(19) United States
(12) Patent Application Publication
(10) Pub. No.: US 2014/0185843 A1
(43) Pub. Date: Jul. 3, 2014

(54) AUDIO EQUIPMENT INSTALLATION INFORMATION PROVIDING SYSTEM AND METHOD, PERSONALIZED AUDIO PROVIDING SERVER

(71) Applicant: Korea Electronics Technology Institute, Gyeonggi-do (KR)

(72) Inventor: Yong Ho KIM, Bucheon-si (KR)

(73) Assignee: Korea Electronics Technology Institute, Gyeonggi-do (KR)

(21) Appl. No.: 14/075,124

(22) Filed: Nov. 8, 2013

(30) Foreign Application Priority Data
Dec. 27, 2012 (KR) 10-2012-0154013

(51) Int. Cl. H04S 7/00; H04R 5/02

(52) U.S. Cl. CPC H04S 7/301; H04R 5/02
USPC 381/303

(57) ABSTRACT

Provided are a system and method for providing installation information about audio equipment capable of analyzing audio information and producing sound field effect using a smart phone carried by a music listener. A user may receive his or her preferred audio service anywhere at any time by storing and subsequently using the installation information provided to a listener and providing a personalized audio service on the basis of personal information.

### CROSS-REFERENCE TO RELATED APPLICATIONS

This application claims priority under 35 U.S.C. §119 to Korean Patent Application No. 10-2012-0154013, filed on Dec. 27, 2012, the disclosure of which is incorporated herein by reference in its entirety.

### TECHNICAL FIELD

The present invention relates to a system and method for providing installation information about audio equipment and providing audio suitable for a user, and more particularly, to an audio equipment installation information providing system and method for analyzing sound output from a speaker to provide audio equipment installation information suitable for a user, and to a personalized audio providing server for receiving information for each user to provide an audio service suitable for the user.

### BACKGROUND

In related art, sound field control is generally performed by an expert in this field during installation of audio equipment, by disposing the audio equipment and tuning respective speakers depending on an installation environment. Thus, the related art sound field control has difficulties in that cost for the expert should be paid for the sound field control and a non-expert in this field has no knowledge about how to control the audio equipment such that the non-expert cannot generate a sound effect for stereoscopic ambience in an audio space, such as audio direction, distance, etc.

Also, although a music listening environment is configured to generate a sound field effect, the control for this should be performed respectively since a desired sound field effect for the same music may be different depending on personal preference.

Furthermore, although information about the personal music listening environment has been stored, there is no method of transmitting the information to the audio equipment, such that it may be difficult to configure the personal music listening environment.

### SUMMARY

Accordingly, the present invention provides a personalized audio providing server for automatically transferring personal sound field setting information to an audio equipment and an audio equipment installation information providing system and method for transferring audio equipment installation through a sound analysis using the smart phone and thus assisting a user, who is a non-expert, in setting a listening environment

In one general aspect, an audio equipment installation information providing system includes: an audio information acquisition unit configured to acquire audio information output from an audio equipment; an audio information analysis unit configured to analyze the audio information acquired by the audio information acquisition unit; and an installation information generation unit configured to generate installation information about the audio equipment on the basis of an analysis result for the audio information of the audio information analysis unit.

The audio information acquisition unit, the audio information analysis unit, and the installation information generation unit may be implemented as a program in a smart phone.

The audio equipment installation information providing system may further includes a position information collection unit configured to collect information about the current position where the audio information is acquired, in which the installation information generation unit generates the installation information on the basis of the analysis result of the audio information analysis unit and the position information.

In another general aspect, an audio equipment installation information providing method includes: receiving audio information output from an audio equipment; analyzing the received audio information; generating installation information about the audio equipment on the basis of the analysis result for the audio information; and collecting position information where the audio information is received, in which the generating of the installation information about the audio equipment includes generating the installation information about the audio equipment on the basis of the analysis result for the audio information and the position information.

In still another general aspect, a personalized audio providing server includes: a receiver configured to receive personalized audio setting information and audio equipment installation information; a controller configured to select music to be output on the basis of the personalized audio setting information and generate music output information in consideration of the selected music and the audio equipment installation information; and a transmitter configured to transmit the generated music output information to the audio equipment.

Other features and aspects will be apparent from the following detailed description, the drawings, and the claims.

### BRIEF DESCRIPTION OF THE DRAWINGS

FIG. 1 illustrates a process of providing audio equipment installation information using an audio equipment installation information providing system and method according to an embodiment of the present invention.

FIG. 2 illustrates an aspect where audio in a space is transferred.

FIG. 3 illustrates a process of generating installation information through an audio analysis.

FIG. 4 is a block diagram illustrating a structure of an audio equipment installation information providing system according to an embodiment of the present invention.

FIG. 5 is a flowchart illustrating a process of an audio equipment installation information providing method according to an embodiment of the present invention.

FIG. 6 illustrates a process of providing a personalized service by a personalized audio providing server according to an embodiment of the present invention.

FIG. 7 is a block diagram illustrating a structure of a personalized audio providing server according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Hereinafter, embodiments of the present invention will be described in detail with reference to the accompanying drawings.

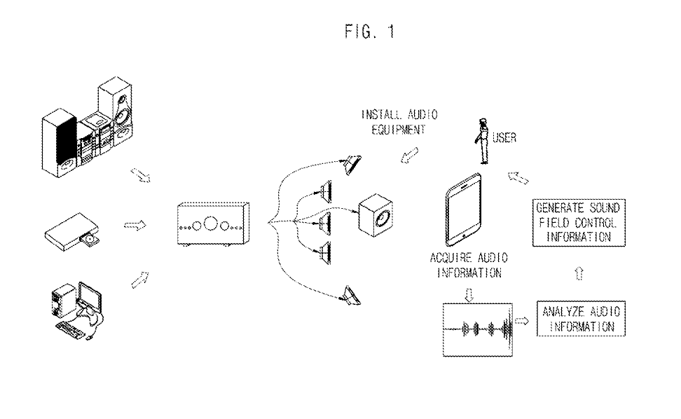

FIG. 1 illustrates a process of providing audio equipment installation information using an audio equipment installation information providing system and method according to an embodiment of the present invention.

Unlike the related art, the present invention relates an audio equipment installation information providing system and method capable of allowing a listener, who has no special knowledge about sound field control, to easily install audio equipment, by using a smart phone to analyze the audio information and provide the installation information about the audio equipment on the basis of the analysis result.

Accordingly, as shown in FIG. 1, when audio is output through previously installed audio equipment, a smart phone owned by a listener acquires information about the audio. The smart phone analyzes the acquired audio information, and then generates sound field control information on the basis of the analysis result. The smart phone provides the generated sound field control information to a listener, and thus the listener can adjust the disposition of the audio equipment on the basis of the audio equipment installation information, thereby obtaining a sound effect for stereoscopic ambience.

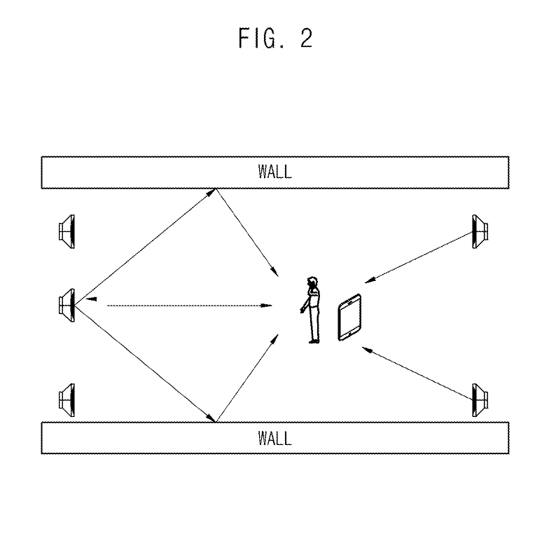

FIG. 2 illustrates an aspect where audio in a space is transferred.

As shown in FIG. 2, the audio information in an indoor space is directly transferred, or reflected by a wall and then transferred. The smart phone analyzes all of the audio information directly transferred or reflected and then transferred from the audio equipment to generate sound field control information.

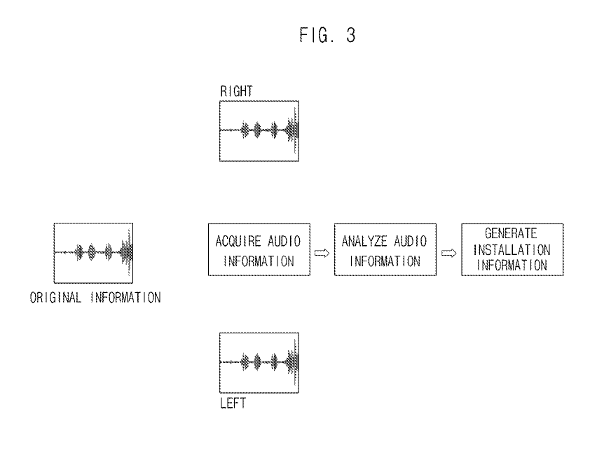

FIG. 3 illustrates a process of a smart phone generating installation information through an audio analysis.

As shown in FIG. 3, the smart phone receives original audio information, analyzes audio output from left and right speakers, and provides information about a direction and position of each speaker to the user of the smart phone to provide installation position information suitable for a user environment.

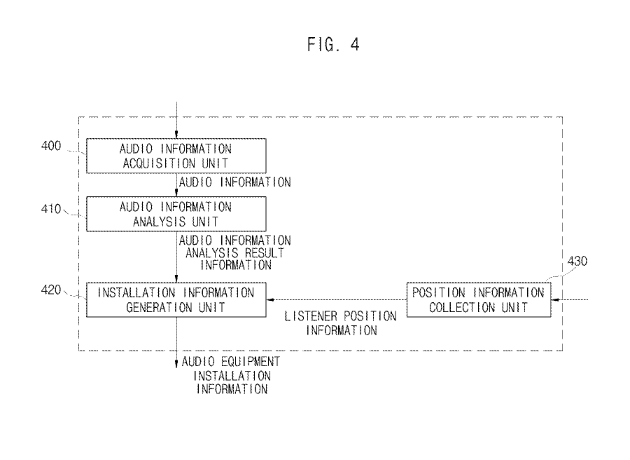

FIG. 4 is a block diagram illustrating a structure of an audio equipment installation information providing system according to an embodiment of the present invention.

The audio equipment installation information providing system according to an embodiment of the present invention includes an audio information acquisition unit 400, an audio information analysis unit 410, an installation information generation unit 420, and the position information collection unit 430.

The audio information acquisition unit 400 acquires audio information output from the audio equipment. As described with reference to FIG. 2, the audio information acquisition unit 400 acquires all of the audio information directly transferred, or reflected by a wall and then transferred from the audio equipment in an indoor space, and transfers the acquired audio information to the audio information analysis unit 410.

The audio information analysis unit 410 analyzes the audio information transferred from the audio information acquisition unit 400. The audio information analysis unit 410 compares the transferred audio information with previously stored optimal audio information to analyze the difference therebetween and generate information about the current position and direction of the audio equipment, or the number of speakers, using the transferred audio information. The audio information analysis unit 410 transfers the analysis result information to the installation information generation unit 420.

The installation information generation unit 420 receives the analysis result for the audio information from the audio information analysis unit 410 and generates installation information about the audio equipment currently outputting audio on the basis of the analysis result. The audio equipment installation information may include information about change in positions and directions of the current speakers or adjustment of the number and volumes of the speakers on the basis of the analysis result of the audio information analysis unit 410.

The installation information generation unit 420 may transfer the generated audio equipment installation information to a listener in a data format, or in a picture format capable of showing the position and direction of the speaker in consideration of the size of the indoor space.

The audio equipment installation information providing system according to an embodiment of the present invention may further include a position information collection unit 430. The position information collection unit 430 collects information about a distance and direction between the audio equipment and the current listener, from position information or audio information about the current listener in the indoor space.

The position information collection unit 430 transfers the collected position information about the listener to the installation information generation unit 420. The installation information generation unit 420 generates the installation information of the audio equipment in consideration of the position information and also the analysis result information of the audio information analysis unit 410.

The listener can adjust the disposition of the audio equipment on the basis of the audio equipment installation information output by the installation information generation unit 420. Thus, the listener may listen to music through the deposition after disposing the audio equipment to obtain the optimal sound field effects, and store and subsequently use the installation information whenever listening to music.

Also, according to the present invention, the audio information acquisition unit 400, an audio information analysis unit 410, an installation information generation unit 420, and the position information collection unit 430 may be implemented as a program in a smart phone. Thus, the user of the smart phone may obtain desired sound field effects anywhere at any time, and store and subsequently use the desired sound field effects.

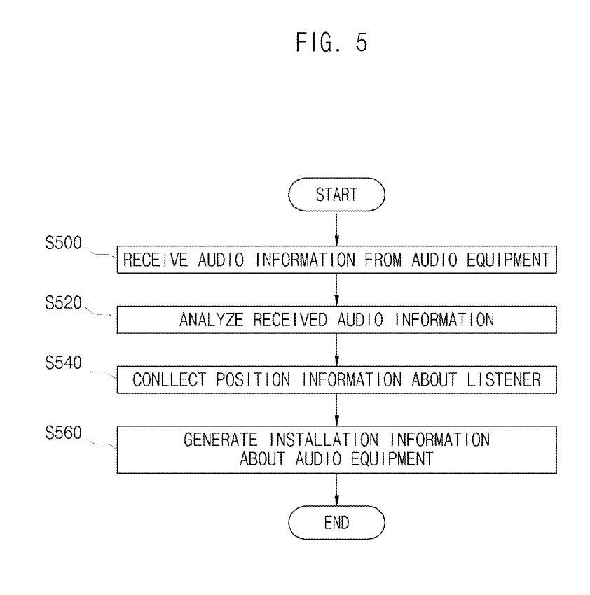

FIG. 5 is a flowchart illustrating a process of an audio equipment installation providing method according to an embodiment of the present invention.

The audio equipment installation information providing method according to an embodiment of the present invention is characterized by being provided by a smart phone. A music listener uses his or her own smart phone to receive audio information from the audio equipment in operation S500 and analyze the received audio information in operation S520.

The smart phone may generate the audio equipment installation information on the basis of the analysis result for the audio information in operation S560 and provide the generated audio equipment installation information to the music listener.

Also, the smart phone may collect position information about a listener, such as distance information between the smart phone and the audio equipment, acquired through the analysis of audio information or current position information about the smart phone in operation S540, and generate the audio equipment installation information on the basis of the position information about the listener and provide the generated audio equipment installation information to the listener.

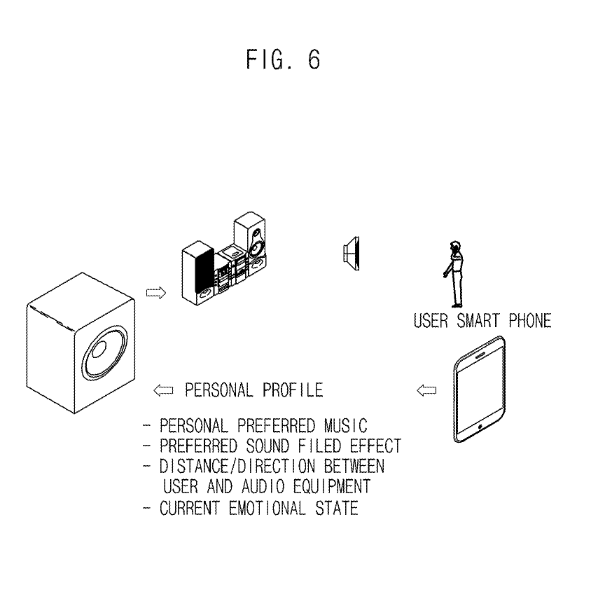

FIG. 6 illustrates a process of providing audio to a listener by a personalized audio providing server according to an embodiment of the present invention.

As shown in FIG. 6, a listener transfers, to a personalized audio providing server, listener profile information such as the current emotional state of the listener acquired through the analysis of distance/direction between the listener and the audio equipment or personal activity status based on desired music, sound field effect, and position information.

When the personalized audio providing server receives the profile information from the listener, the personalized audio providing server selects a music suitable for the listener on the basis of the profile information and generates music output information including information about the selected music to transfer the generated music output information to the audio equipment. The audio equipment provides audio suitable for the listener, by outputting music on the basis of the music output information transferred from the personalized audio providing server.

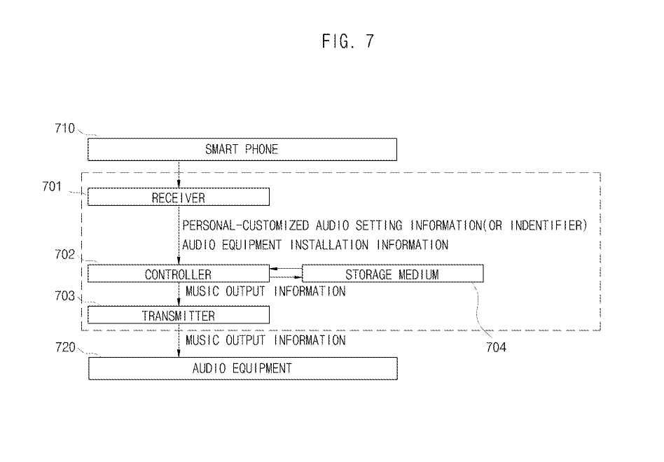

FIG. 7 is a block diagram illustrating a structure of a personalized audio providing server according to an embodiment of the present invention.

A personalized audio providing server 700 according to an embodiment of the present invention includes a receiver 701, a controller 702, a transmitter 703, and a storage medium 704.

The receiver 701 may receive personal profile information, which may be performed by a smart phone 710 owned by the listener, from the listener. The listener may store information, such as a type, title, and sound field effect of desired music, in the smart phone 710 and then, when he or she feels like listening to music, transfer the stored information to the personalized audio providing server 700 to listen to music.

The receiver 701 transfers the received personal profile information to the controller 702.

In this case, the receiver 701 may receive the audio equipment installation information and transfer the received audio equipment installation information along with the profile information to the controller 702. The audio equipment installation information may be received from the smart phone 710 or the audio equipment 720.

The controller 702 generates the music output information including sound field effect information and information about music suitable for the current listener on the basis of the personal profile information transferred from the receiver 701. Alternatively, the controller 702 may identify information about position and direction of speakers from the audio equipment installation information and generate the music output information on the basis of sound field effect preferred by a listener and deposition of the current audio equipment.

The receiver 701 may receive an identifier, instead of the profile information, from the smart phone 710 to transfer the identifier to the controller 702. In this case, the controller 702 retrieves the profile information previously stored in the storage medium 704 using the identifier, and generates the music output information on the retrieved profile information.

The controller 702 transfers the generated music output information to the audio equipment 720 through the transmitter 703. The audio equipment 720 outputs music suitable for the current state of the listener on the basis of the received music output information.

In this case, the personalized audio providing server 700 may provide only music information, and the music file may be stored in the audio equipment 720. Alternatively, the audio equipment 720 may be allowed to replay in a streaming manner the music stored in the personalized audio providing server 700.

The present invention can control the output of the audio equipment on the basis of personal sound field setting information, thereby providing a personalized audio service. The present invention can also use a smart phone to analyze sounds needed during audio equipment installation and transmit installation information, thereby providing a listening environment personalized for user preference.

The above-described subject matter of the present invention is to be considered illustrative and not restrictive, and it should be understood that numerous other modifications and embodiments can be devised by those skilled in the art that will fall within the spirit and scope of the principles of the present invention. Accordingly, the embodiments of the present invention are to be considered descriptive and not restrictive of the present invention, and do not limit the scope of the present invention. The scope of the present invention should be determined by the following claims and their appropriate legal equivalents.

What is claimed is:

1. An audio equipment installation information providing system comprising:
an audio information acquisition unit configured to acquire audio information output from audio equipment;
an audio information analysis unit configured to analyze the audio information acquired by the audio information acquisition unit; and
an installation information generation unit configured to generate installation information about the audio equipment on the basis of the analysis result for the audio information of the audio information analysis unit.

2. The audio equipment installation information providing system of claim 1, wherein the audio information acquisition unit, the audio information analysis unit, and the installation information generation unit are implemented as a program in a smart phone.

3. The audio equipment installation information providing system of claim 1, further comprising a position information collection unit configured to collect information about the current position where the audio information is acquired,
wherein the installation information generation unit generates the installation information on the basis of the analysis result of the audio information analysis unit and the position information.

4. The audio equipment installation information providing system of claim 1, wherein the audio information analysis unit compares the audio information with a previously stored audio information to generate the analysis result.

5. An audio equipment installation information providing method comprising:
receiving audio information output from an audio equipment;
analyzing the received audio information; and
generating installation information about the audio equipment on the basis of the audio information analysis result.

6. The audio equipment installation information providing method of claim 5, wherein the generating of installation information about the audio equipment comprises generating installation information including at least one of the position, direction, number, and volume of the audio equipment.

7. The audio equipment installation information providing method of claim 5, further comprising collecting position information where the audio information is received,
wherein the generating of the installation information about the audio equipment comprises generating the installation information about the audio equipment on the basis of the analysis result for the position information and the audio information.

8. A personalized audio providing server comprising:
a receiver configured to receive personalized audio setting information and audio equipment installation information;
a controller configured to select music to be output on the basis of the personalized audio setting information and generate music output information in consideration of the selected music and the audio equipment installation information; and
a transmitter configured to transmit the generated music output information to the audio equipment.

9. The personalized audio providing server of claim 8, further comprising a storage medium configured to store the personalized audio setting information,
wherein the receiver receives an identifier, and
the controller retrieves the personalized audio setting information on the basis of the identifier to generate the music output information.
